(19) United States
(12) Patent Application Publication
(10) Pub. No.: US 2010/0046510 A1
(43) Pub. Date: Feb. 25, 2010

(54) COMMUNICATION IN A COMMERCIAL CONTEXT

(76) Inventors: Marcellus C.H. Koster, Reading, MA (US); Mark J. Mildrum, Bedford, MA (US); Eleanor F.R. Hagopian, Bolton, MA (US)

Correspondence Address: FISH & RICHARDSON PC, P.O. BOX 1022, MINNEAPOLIS, MN, 55440-1022, US

(21) Appl. No.: 12/194,124

(22) Filed: Aug. 19, 2008

(51) Int. Cl. H04B 7/216

(52) U.S. Cl. 370/355

(57) ABSTRACT

Among other things, a hardware-agnostic speech port carries, to and from any arbitrary speech device, analog speech signals associated with an order placed by a customer of a quick serve restaurant. A network port carries digitized versions of the speech signals through a packet-switched network to and from any arbitrary device that has access to the packet-switched network. A processor connected to the speech port and the network port processes and routes the speech signals to enable the arbitrary device to provide a function associated with processing the customer order. The function provided by the processor can include enabling a representative of the quick serve restaurant to listen in on a conversation associated with the order and/or to take over a conversation between the customer and an order taker.

### TECHNICAL FIELD

This description relates to communication in a commercial context.

### BACKGROUND

In a quick-serve restaurant, for example, customers in the restaurant and in a drive-thru lane, employees at order-taking locations, employees in the kitchen, agents at remote call centers, and other employees may communicate with respect to orders being placed and filled at the restaurant. Some of the communications occur electronically, for example, when a customer in a drive-thru lane speaks through an intercom system to an order taker in the restaurant.

### SUMMARY

In general, in an aspect, a hardware-agnostic speech port carries, to and from any arbitrary speech device, analog speech signals associated with an order placed by a customer of a quick serve restaurant. A network port carries digitized versions of the speech signals through a packet-switched network to and from any arbitrary device that has access to the packet-switched network. A processor connected to the speech port and the network port processes and routes the speech signals to enable the arbitrary device to provide a function associated with processing the customer order.

Implementations may include one or more of the following features. The arbitrary speech device includes an intercom at a drive-thru of the quick serve restaurant. The apparatus is located at the quick serve restaurant. The arbitrary device that has access to the packet-switched network is an order-taking station at a call center that is remote from the quick-serve restaurant. The function provided by the processor includes responding to control signals from a participant selector to govern the parties to a conversation related to the order. The function provided by the processor includes enabling a representative of the quick serve restaurant to listen in on a conversation associated with the order. The representative may listen in but not participate in the conversation. The representative is a person who is preparing food for the order. The representative is a person who is managing the restaurant. The function provided by the processor can be controlled by a representative of the restaurant. The function provided by the processor includes enabling a representative of the quick serve restaurant to take over a conversation between the customer and an order taker. The order taker is excluded from the conversation. The order taker is permitted to listen to but not participate in the conversation.

These and other aspects and features, and combinations of them, can be expressed as methods, systems, apparatus, means for performing functions, program products, databases, business methods, and in other ways.

Other aspects, features, and advantages will become apparent from the following description and from the claims.

### DESCRIPTION

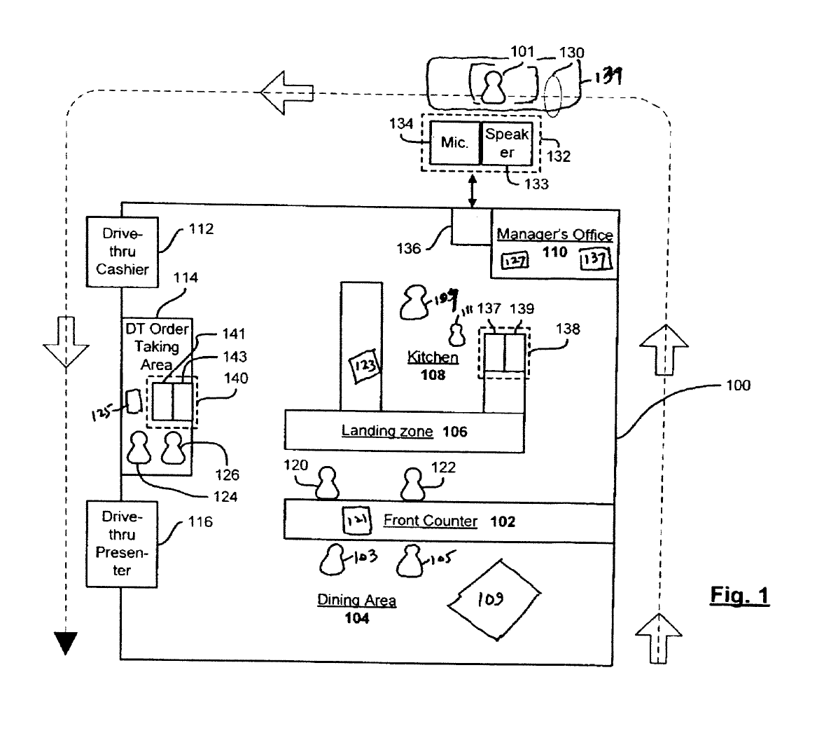

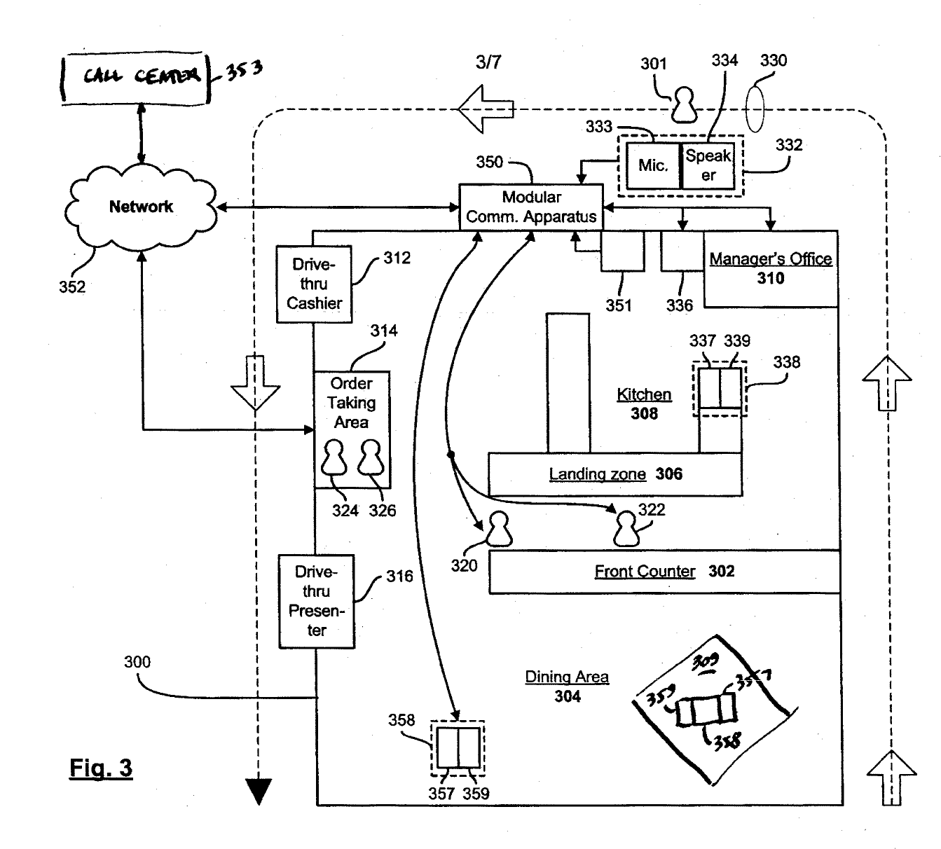

FIGS. 1 and 3 are schematic views of quick-serve restaurants.

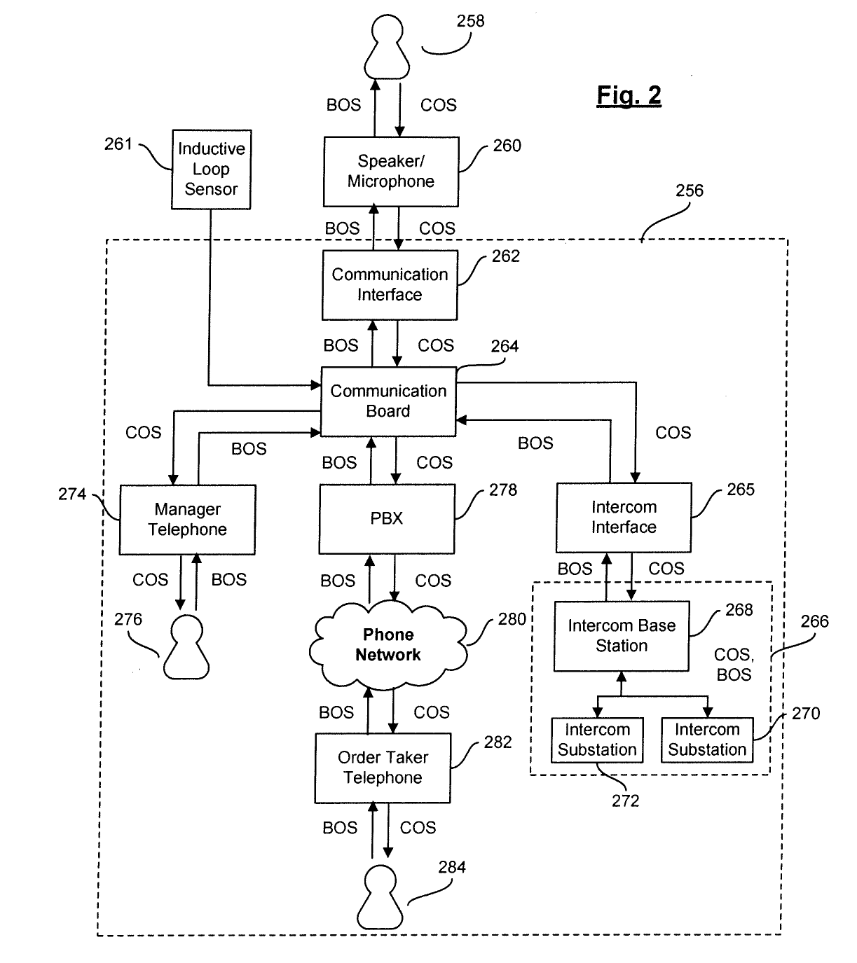

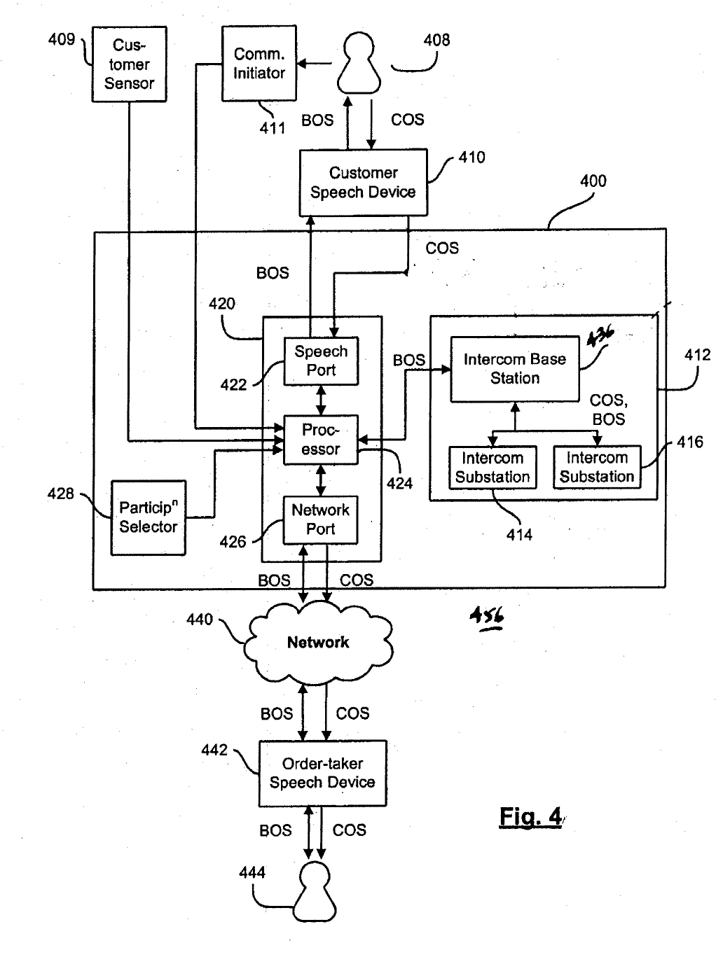

FIGS. 2 and 4 are block diagrams of communication systems.

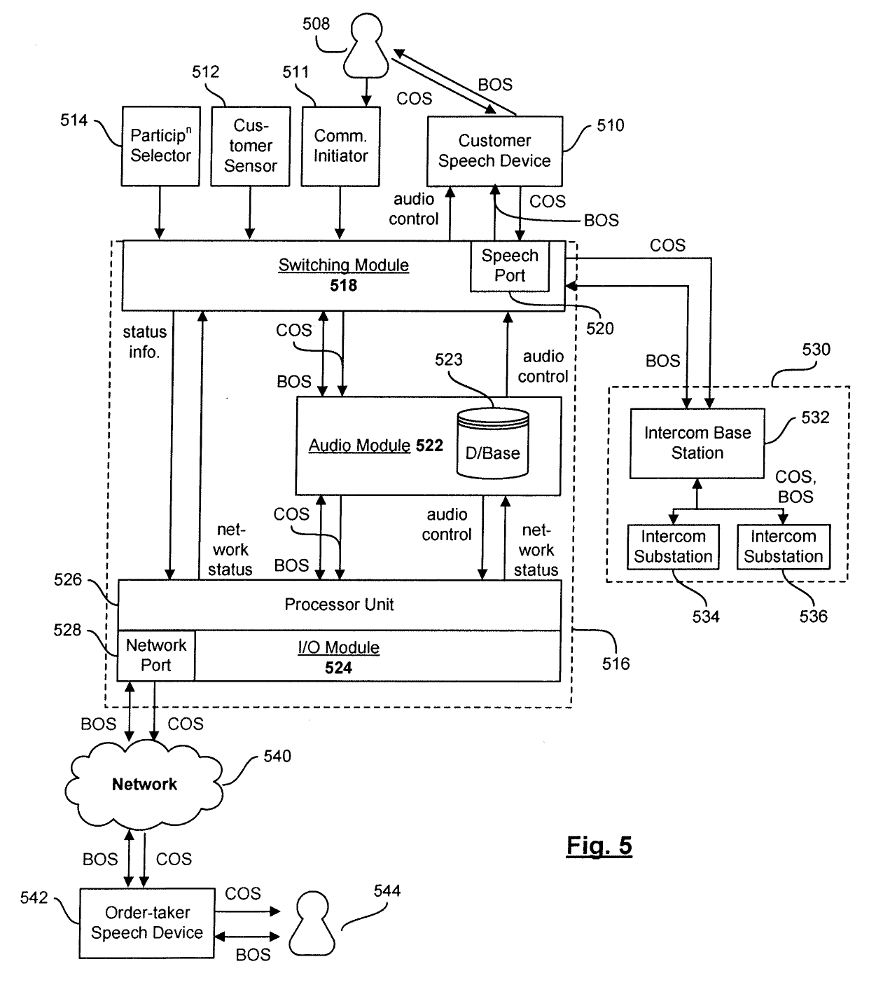

FIG. 5 is a block diagram of a communication system.

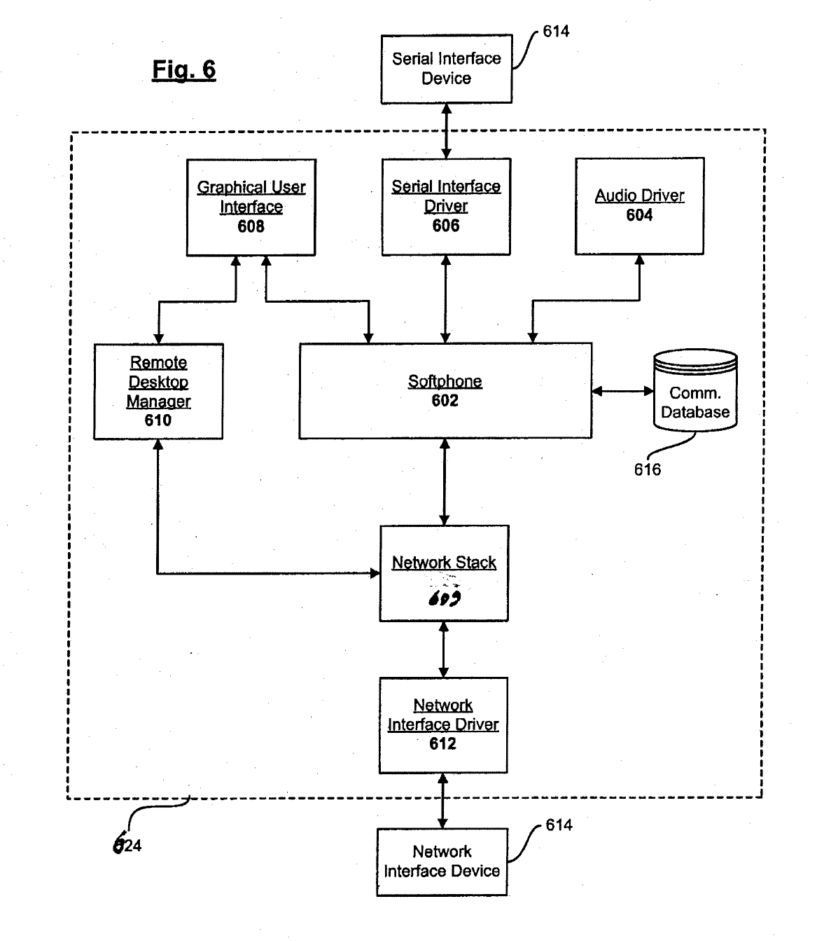

FIG. 6 is a block diagram of an I/O module.

In what follows, we use the term “order” to include, for example, a set of items (goods or services or both) to be delivered to a customer. A “delivery point” includes, e.g., a location where the customer receives the order, for example, at a table in a restaurant, at the front counter at a restaurant, or at a window in a drive-thru lane. “Business-originated speech” (“BOS”) includes, for example, speech of an order-taker or other employee or agent in the quick-serve context. Business-originated speech can be directed at a customer or another representative of the restaurant. “Customer-originated speech” (“COS”) includes, for example, speech of a customer that is directed to an order-taker or other employee or agent of the store. We use “commercial context” to mean, for example, any situation in which goods and/or services are ordered and the orders are filled, at retail or wholesale. Commercial contexts can include physical locations such as quick-serve restaurants, or other restaurants, or other retail or wholesale facilities where the order is filled and delivered in person to the customer, or may include contexts such as the Web, or telephone, or others, in which the customer does not appear in person at the place where the order is being filled.

Referring to FIG. 1, in some examples of a commercial context in which orders are taken and filled, a quick-serve restaurant 100 includes a front counter 102, a dining area 104 that includes tables 109, a kitchen 108, one or more drive-thru lanes having order stations 132, and one or more drive-thru order-taking areas 114.

In some modes of operation, front-counter workers 120, 122 at the front counter 102 take food orders and payments from customers 103, 105 who arrive on foot. At a kitchen 108, workers 107, 111 receive the food orders, produce food items to fulfill the food orders and send at least some of the food items to a landing zone 106. The front-counter workers 120, 122 deliver the food items from the landing zone (and sometimes other food items that belong to orders) to the customers at the front counter 102 or sometimes at tables in the dining area. Customers leave the restaurant 100 with the food orders or eat the food orders in the dining area 104. Other orders can be taken and delivered at the drive-thru lane as explained later.

The taking, reporting, filling, and delivery of orders is sometimes recorded and managed electronically using an order entry system that can include terminals 121, 123, 125 on the front counter 102, in the kitchen 108, and in the drive-thru order-taking area 114. A central server 127, for example, in a manager's office 110, can interact with the terminals. In addition, an audio intercom system can be used in taking orders. The audio intercom system may include a central intercom base station 136 and intercom substations 138, 140 at-the drive-thru lane, the drive-thru order-taking area 114, the front counter 102, and the kitchen 108. The intercom substations can be in the form of squawk boxes or in some cases headsets (not shown) worn by order-takers, cooks, and others.

In some modes of order processing, a customer 101 in a car 139 can place and pick up orders at a drive-thru lane outside the restaurant. In the drive-thru mode, the approach of the customer 101 is detected by an inductive loop sensor 130 located in the drive-thru lane. A drive-thru order taker 124, 126 at the drive-thru order-taking area 114 greets the customer 101 by speaking into a microphone 141 of a headset or other intercom substation 140. The order taker's voice is conveyed through the intercom base station to a speaker 133 at the station 132 and heard there by the customer. The customer 101 can respond by placing a food order by speaking into a microphone 134 of the drive-thru order station 132. The customer 101 and the drive-thru order taker 124, 126 may converse through drive-thru order station 132 and the intercom substation 140 respectively.

Customer-originated speech is converted into an electrical signal by the microphone 134 and sent in analog form to the intercom base station 136, which forwards it to the intercom sub-stations 138 and 140, where it is played over the speakers 139 and 143 respectively and possibly in headphones worn by representatives of the restaurant. Business-originated speech from the drive-thru order taker 124, 126 (such as the initial greeting to the customer 101) is converted into an electrical signal by the microphone 141 and sent in analog form over a wired connection to the intercom base station 136. The intercom base station 136 forwards the signal both to the drive-thru order station 132 (where it is played to the customer 101 by a speaker 134), and also to an intercom sub-station 138 located in the kitchen 108 (where it is played by a speaker 139).

Although there might be a microphone 137 in the intercom substation 138, it is not used by the kitchen -workers-to take part in the conversation.

Thus, the order-takers 124, 126 hear customer-originated speech over speaker 143, and workers in the kitchen 108 can hear both sides of the order-related conversation between the customer 101 and the order-takers 124, 126. The workers can follow the conversation and begin preparing the food items relating to the food order while the conversation is still in progress and before the order is formally entered into the order entry system.

After placing the food order, the customer 101 drives to a drive-thru cashier 112 and pays for the food. Workers in the kitchen 108 produce food items to fulfill the food order and send the food items to a drive-thru delivery station 116, where an employee of the restaurant delivers the order to the customer 101.

The restaurant 100 may also include a manager's office 110 from which both sides of the order-related conversation can be heard on a speaker 137 of another intercom sub-station or on the headphones of a headset used by the manager (not shown).

Thus, the intercom sub-station serves as an intermediary to send and receive analog audio signals to and from each of the intercom substation and headsets to facilitate the taking, entry, fulfilling, and delivery of each order.

FIG. 2 shows a communication system in a quick-serve restaurant with respect to a drive-thru lane. An inductive loop sensor 261 (or a wide variety of other kinds of sensors or vehicle detection devices) detects the approach of a customer 258. The customer 258 has an order-related conversation with an employee or agent of the restaurant using a speaker/microphone unit 260. The speaker/microphone unit 260 (which can be part of an intercom substation, for example) converts the customer's customer-originated speech into an electrical signal and plays signals representing business-originated speech to the customer 258. The speaker/microphone unit 260 is in two-way communication with a communication interface 262, which processes and adapts the electrical signals for compatibility with a communication board 264. The communication board does not contain logic or processing capability but provides an easy way to connect to the PBX 278.

The PBX is configurable to communicate speech signals (through the communication board) to and from any one or more of: a manager telephone 274 or (through an intercom interface 265) a store intercom system 266. The PBX 278 also monitors the inductive loop sensor 261 to automatically initiate a call when the customer 258 arrives (e.g., drives on the loop) and/or automatically ends a call if the customer 258 departs (e.g., drives off the loop).

The store intercom system 266 comprises an intercom base station 268 and intercom substations 270, 272 (although only two are shown, there can be many more intercom substations, as needed). The intercom substations can be in the form of speaker/microphone combinations, squawk boxes, or headsets. When the PBX 278 is configured to communicate with the store intercom system 266, the customer 258 can have an order-related conversation with a drive-thru order taker (not shown). During such a conversation, other intercom substations may “overhear” the conversation as explained above with reference to FIG. 1. For example, a cook in the kitchen 108 may overhear when someone in a car in the drive-thru lane orders a hamburger with everything on it.

The PBX 278 interfaces with a phone network 280, through which it communicates with an order-taker telephone 282. The order-taker telephone 282 may be in the restaurant or at a remote location such as a remote call center of the kind described in U.S. Pat. No. 7,110,964, incorporated here by reference. An order-taker 284 uses the order-taker telephone 282 to have an order-related conversation with the customer 258. Thus in some cases, the order-taking process is conducted between a customer at the drive-thru lane and an order-taker located at a call center that is remote from the restaurant.

FIG. 3 shows a quick-serve restaurant that provides for better communication in a commercial context. In the implementation illustrated in FIG. 3, better communication is facilitated by a communications device 350 which connects, on one hand, agnostically to any cable that carries analog speech signals, for example, from the drive-thru intercom, and on the other hand provides a connection to any Internet protocol network to send and receive voice over IP (VoIP) packets that correspond to analog speech signals. The communications device can therefore be easily and cheaply installed in any location where an analog speech cable carries order-related speech and where an IP-network (such as the Internet) is accessible. The existing equipment at the commercial establishment need not be altered or replaced.

The communications device can be located, for example, in a quick-serve restaurant 300, which includes a front counter 302, a dining area 304, a kitchen 308, and customer speech devices 332, 358 (including possibly one located in the dining area 304). The placing, reporting, filling and delivery of orders may be recorded and managed electronically using an order entry system that can include terminals (not shown) on the front counter 302, the kitchen 308, and in an order-taking area 314. A central server (not shown), located for example in a manager's office 310, can interact with the terminals.

As in FIG. 1, some walk-in customers order food and pay the front-counter workers 320, 322 for the order at the front counter 302. Kitchen employees get the orders, make the food items to fill the orders and drop the food items at a landing zone 306. The customers collect the food from the front-counter workers 320, 322, or else have it delivered to them in the dining area 304.

Some walk-in customers order food by speaking into a microphone 357 of a customer speech device 358 inside the restaurant 300. For example, the customer speech device 358 may be a telephone on a dining table (not shown) in the dining area 304. In another example, the customer speech device 358 might be a telephone in a free-standing telephone tree in the restaurant. The microphone 357 transmits customer-originated speech, and a speaker 359 plays business-originated speech

The communications device 350 is also connected to a network 352 (such as a LAN, a WAN, or a publicly accessible network such as the Internet) and other speech devices. These other devices might include a store intercom system, comprising an intercom base station 336 and one or more intercom substations 338, headsets and microphones (not shown) of front-counter workers 320, 322, and a phone (not shown) in the Manager's office 310. The communication device 350 can connect to the intercom base station 336 as if the communication device were an intercom substation, again making the installation of the communication device 350 in the commercial establishment cheap and simple. In addition, the communications device 350 can use the computer network 352, to communicate with an order-taker 324, 326 in the order-taking area 314. The order-taking area 314 may be within the restaurant 300 or offsite—for example, in a remote call center 353. Communication over the network 352 might use network protocols for encoding and transmitting audio data over a computer network, such as a protocol that uses the Voice over Internet Protocol (VoIP).

The communications device 350 routes customer- and business-originated speech to a customer and to the employees and mangers, or the call-center agents, depending on the configuration of a participation selector 351. Additional customers can be served at the same time by adding additional communication devices each of which can serve one customer.

Each device connected directly to the communications device 350, as well as any devices with which it communicates via the network 352, may be assigned an independent participation level using a participation selector 351. The participation levels may include: participation both as a destination for speech (customer- or business-originated or both) and as a source for business-originated speech; participation as a destination for speech only (customer- or business-originated or both); participation as a source only for business-originated speech; and no participation in the conversation. Multiple devices may be chosen as destinations for each type of speech, and multiple sources may be chosen for business-originated speech.

For example, the participation selector 351 may be configured so that the communications device 350 routes all customer-originated speech both to the order-taker 324 (via the network 352) and to the store intercom system (via the intercom base station 336), but accepts business-originated speech only from the order-taker 324. In this configuration, the customer and the order-taker 324 have an order-related conversation in which other employees do not actively participate. However, other employees—for example, workers in the kitchen 308—overhear the conversation (listen in) through the speaker 339 of the intercom substation 338, and can, for example, begin preparing the food items relating to the food order while the conversation is still in progress. Although there might be a microphone 337 in the intercom substation 338, it may or may not be used to take part in the conversation.

The participation selector 351 may also be reconfigured on-the-fly in the middle of a conversation. For example, a manager (not shown) in the manager's office, listening in to a conversation between the customer 301 and an order-taker 324, 326, might dynamically reconfigure the participation selector 351 so as to take control of the conversation from the order-taker 324, 326 upon hearing something that requires the manager's input. For example, the manager might jump in to inform the customer 301 that the restaurant is out of one of the items being ordered. In this example, the manager might either reduce the order-taker's 324, 326 participation in the conversation to permit the order-taker to listen only, take over the conversation and thereby remove the order taker 324, 326 from the conversation entirely, or else leave the order-taker's participation level unchanged while the manager is participating in the conversation. Once the conversation is pulled back in this manner, the conversation must be completed with the manager and cannot be returned to the order taker.

In some embodiments, the participation selector 351 might allow for only a subset of the complete range of configuration options described above. For example, the participation selector 351 might be just a single toggle. In one position, this toggle might make the order-takers 324, 326 the sole sources of business-originated speech; and in the other position, make the manager's telephone the sole source of such speech. In either position, the store intercom may be allowed to “listen in.” The participation selector 351 may be physically inside the restaurant 300 as shown in FIG. 3, or located elsewhere, or both.

Workers in the kitchen 308 prepare the food items ordered and deliver them to a landing zone 306. The customer may collect these food items from the front-counter workers 320, 322 at the front counter 302. Alternatively, other employees (not shown) may deliver the food items directly to the customer.

In other examples, the customer sensor 330 could be a weight sensor, an infrared sensor, radar, a rubber hose sensor, a motion sensor, a light beam, ultrasonic, video, or another kind of sense. The customer sensor 330 is preferably stateful—meaning that it indicates the period when a car is present, not just the moment when one arrives or departs—but this is not necessary.

The customer 301 speaks into a microphone 333 of a customer-speech device 332 which is connected to the communications device 350, and hears business-originated speech through a speaker 334. The communications device 350 routes customer- and business-originated speech depending on how the participation selector 351 is configured, and thereby enables the customer 301 to have an order-related conversation with an order taker 324, 326 and/or other employee-participants as already described. The customer 301 then pays for the order at a drive-thru cashier 312 and collects the food items which have been prepared in response to the order at a drive-thru presenter window 316.

The communications device 350 is capable of interfacing with a variety of possible customer-speech devices, including drive-thru lane order-stations commonly found in existing quick serve restaurants and existing store intercom systems. This makes it cheap to install the modular communications apparatus 350, because it works with existing store hardware.

FIG. 4 shows a communication system in a quick-serve restaurant 456 that has a modular communications apparatus. A customer 408 uses a customer speech device 410 to have an order-related conversation with store employees and agents. The customer speech device 410 routes customer-originated speech to a speech port 422 in a modular communications apparatus 420 and to a store intercom system 412, which comprises an intercom base station 436 and intercom substations 416, 414.

The modular communications apparatus 420 comprises, in addition to the speech port 422, a processor 424 and a network port 426. The processor 424 monitors a customer sensor 409, and uses the information so gained to establish and terminate conversations when a customer arrives or departs. The processor 424 also monitors a communication initiator 411, which is an element through which the customer 408 can manually request a new conversation. The customer 408 may do so if, for example, the customer sensor 409 failed for some reason to detect the customer 408's presence, or if the conversation failed or was terminated for some other reason. The communication initiator 411 may be, for example, a simple button near the customer speech device 410. If the customer activates the communication initiator 411—for example, by pressing the button—the processor 424 tries to establish a new conversation, perhaps by trying to contact a new order-taker.

The processor 424 also monitors a participation selector 428, and routes customer- and business-originated speech based on the configuration of the participation selector. The processor 424 routes customer-originated speech to all selected recipients, irrespective of whether they are connected to the modular communications apparatus 420 directly, or indirectly through a network 440 or the intercom system. Likewise, the processor receives business-originated speech from each selected source and forwards it to the customer 408 (via a speaker (not shown) on the customer speech device 410) and to the other recipients selected for business-originated speech. When communication takes place over the network 440, the processor 424 converts speech signals from and to a form suitable for network transmission. In one example, this form is VoIP packets. The processor 424 transmits the speech in this form via the network port 426 to, for example, an order-taker speech device 442. This order-taker speech device 442 may be located inside the restaurant-or at a remote location such as a call center.

For example, the participation selector 428 can be configured so that the processor 424 receives business-originated speech from the order-taker speech device 442 via the network 440 and the network port 426 and routes this speech both to the customer speech device 410 via the speech port 422 as well as to the store intercom system 412. This configuration lets store intercom devices such as the intercom substations 416, 414 “listen in” on the order-related conversation between the customer 408 and the order-taker 444.

In another example, the participation selector 428 can also be configured so that processor 424 does not use the network 440, but instead sends and receives business-originated speech to and from the store intercom system 412 by means of the intercom base station 336. In this example, a store employee such as a manager (not shown) uses one of the intercom substations 416, 414 to talk to the customer 408.

As explained above, the participation selector 428 may be reconfigured on-the-fly during a conversation to change the set of participants in the conversation and their levels of participation.

In some implementations, the processor can also send speech to and from other sources and recipients (other than the order takers) through the network using VoIP. The choice of other sources and recipients could be based on how the participation selector is configured. The other sources and recipients could be at the commercial establishment or remote from it.

FIG. 5 shows another configuration of a modular communications apparatus. A customer 508 interacts with a customer speech device 510 to have an order-related conversation with store employees and agents. The customer speech device 510 communicates with a speech port 520 in a modular communications apparatus 516. The speech port 520 is hardware agnostic: it is configured to receive and send standard analog electrical signals representing audio to and from any kind of device. This hardware agnosticism makes it relatively cheap to install the modular communications apparatus 516.

The speech port 520 is part of a switching module 518, which also monitors a participation selector 514, a customer sensor 512, and a communication initiator 511. The switching module 518 routes conversations based on how the participation selector 514 is configured. For example, the participation selector 514 can be configured so that the switching module 518 routes speech to a store intercom system 530. If the store intercom 530 is selected as a recipient for customer-originated speech, the switching module forwards such speech from the customer speech device 510 to the store intercom 530 via an intercom base station 532; and if the store intercom 530 is selected as a source of business-originated speech, the switching module 518 accepts such speech from the intercom base station 532 and routes it to the customer speech device 510 through the speech port 520. Similarly, if the participation selector 514 is configured to make a network device (such as an order-taker speech device 542) a recipient of any kind of speech, or a source of business-originated speech, then the switching module 518 cooperates with an audio module 522 and an I/O module 524 (both described below) to route speech signals to and from it.

The audio module 522 controls audio settings (for example, the microphone and speaker volume) of some or all of the devices involved in the conversation. Some or all of the audio signals involved can be made to pass through the audio module 522 en route from their source to their destination. For example, customer- and business-originated speech signals pass through the audio module 522 on their way from the switching module 518 to the I/O module 524, and on their way back. Similarly, speech signals travelling from the switching module 518 to the store intercom 530 and back might be detoured (not shown) through the audio module 522. The audio module 522 includes a device database 523 of information about the audio characteristics of various devices—such as, for example, any order stations being used as customer speech devices, the store intercom 530, the order-taker speech device 542, and other speech devices (not shown) connected to the modular communications apparatus 516 either directly or through a network 540—and the control instructions that can control them. Based on the information in the device database 523 and the audio characteristics of the speech signals passing through, the audio module 522 might generate audio control signals for some or all of the devices. For example, it might generate a signal to a drive-thru order-station (not shown) operating as the customer speech device 510 to increase its microphone volume if the customer-originated speech signal is too soft, or decrease it, if the signal is too loud.

The main purpose of the I/O module 524 is to control transmission and routing of speech over the network 540. The I/O module 524 contains a processor unit 526 and a network port 528. From the switching module 518, the I/O module 524 receives status information, including the configuration of the participation selector 514, the status of the customer sensor 512, and the status of the communication initiator 511. From the audio module 522, the I/O module 524 receives speech signals and also possibly audio control information. In return, I/O module 524 sends network status information—such as whether a live network connection exists and is working properly—to both the audio module 522 and the switching module 518, which can use this information to determine whether or not to try and send speech and control information via the network 540.

The processor unit 526 transforms audio information to and from a form suitable for transmission over the network 540. For example, if VoIP is being used, the processor unit 526 might convert analog audio signals from the audio module 522 into VoIP packets suitable for sending over the network 540 (including compressing and encrypting them, if desired), and convert incoming VoIP packets into analog audio signals for the audio module 522. The processor unit 526 also places appropriate destination information into these packets based on how the participation selector 514 is configured. For example, it might put the network addresses of all devices selected as recipients of each form of speech (customer- and business-originated) into the packets representing that form of speech sent out on the network 540.

The processor unit 526 also begins and ends conversations as customers are detected arriving and departing by the customer sensor 512, and when the customer 508 manually requests a new conversation by activating the communication initiator 511. OK . . . do we also want to say how/when conversations end? If the customer presses the button, the call terminates in a different way than if they drive off the mag loop. Plus with inline, calls aren't terminated by drive offs.

The processor unit 526 may also support other management functions, such as detecting viruses in incoming information; running a network firewall; recording and time-stamping conversations and information about conversations in a database (not shown) for later playback and analysis; hosting configuration software for the components of the modular communications apparatus 516 and connected devices; and providing remote access to this configuration software via the network, for example by providing a remote desktop control service.

The network port 528 transmits and receives information over the network 540. Among other devices (not shown) on the network 540, it might communicate with the order-taker speech device 542, which an order-taker 544 uses to have an order-related conversation with the customer 508.

FIG. 6 shows an example of the I/O module 524. A softphone 602—a software program for making voice calls over a computer network—receives incoming audio information from an audio module (not shown) via an audio driver 604 and incoming control information (such as the statutes of a participation selector, a customer sensor, and a communication initiator (all not shown)) over a hardware serial interface device 614 via a software serial interface driver 606. The softphone 602 uses the control information to identify actions (for example to initiate or end a conversation) to perform using a network (not shown), and to identify appropriate routing information for packets on the network. The softphone 602 then uses a network stack 609 to transform the audio information into a form suitable for transmission over a network to the correct recipients, and sends it to a hardware network interface device 614 by way of a network interface driver 612.

The softphone 602 also receives audio information from the network through the network interface device 614, the network interface driver 612, and the network stack 610. The softphone 602 converts this information into a form suitable for use with the audio module and passes it along through the audio driver 604. In addition, the softphone 602 might send incoming audio information back through the network, depending on how the participation selector is configured. For example, it might forward business-originated speech received over the network to other network devices (not shown) that are configured to “listen in” on the conversation.

The I/O module 524 also contains a communication database 616 which records network status information and possibly order information for later analysis. For example, the data in the communication database 616 may later be used to train order-takers, or to evaluate and respond to customer complaints. The data may also be used to help debug network-related errors. In some examples, the communication database 602 is a Structured Query Language (SQL) database, e.g., a Microsoft Data Engine (MSDE) database.

In addition, the I/O module 524 might contain a graphical user interface 608 to the softphone 602 and to various management programs (not shown) such as anti-virus software, configuration utilities, firewall software, database access and management software, and so on. The graphical user interface 608 (and by extension the management programs) may be made accessible remotely by a remote desktop manager 610. The remote desktop manager 610 may be any of a number of desktop sharing and/or control systems, such as a Virtual Network Computing (VNC) server or a Remote Desktop Protocol (RDP) service. The remote desktop manager 610 sends and receives the data it requires to function over the network by means of the network stack 610, the network interface driver 612, and the hardware network interface device 614.

The discussion has focused on quick-serve restaurants but the techniques described are applicable to other types of restaurants, other types of quick-serve retail businesses, other types of non-quick-serve retail businesses, and other types of non-retail businesses. As one example, the techniques are also applicable to the food service component of convenience stores that also provide gasoline to automobiles. The items to be included in the orders need not be food items and need not be items that are prepared to order or on the premises where they are to be delivered.

Although many of the techniques described involve wired devices, they may also be applied using wireless devices, including wireless telephones, personal assistants, and other wireless devices.

The customers need not be physically present on the premises to order. They may place orders from other locations, for example, from a desktop computer at home or work or from a device such as a mobile phone while traveling in the vicinity of the place where delivery of the order is to occur.

Although a single participation selector is described that controls the participation level of all the devices involved, multiple participation selectors could be used instead. As an example, each physical location—such as the store and each call center, if any—could have a participation selector controlling only the subset of devices in that location. In this example, some of the participation selectors may be connected to the modular communications apparatus directly, while others would be connected indirectly over a network. These latter selectors would communicate their status to the modular communications apparatus over the network.

Other implementations are also within the scope of the following claims.

1. An apparatus comprising
a hardware-agnostic speech port to carry, to and from any arbitrary speech device, analog speech signals associated with an order placed by a customer of a quick serve restaurant,
a network port to carry digitized versions of the speech signals through a packet-switched network to and from any arbitrary device that has access to the packet-switched network, and
a processor connected to the speech port and the network port to process and route the speech signals to enable the arbitrary device to provide a function associated with processing the customer order.

2. The apparatus of claim 1 in which the arbitrary speech device includes an intercom at a drive-thru of the quick serve restaurant.

3. The apparatus of claim 1 in which the apparatus is located in the quick serve restaurant.

4. The apparatus of claim 1 in which the arbitrary device that has access to the packet-switched network comprises an order-taking station at a call center that is remote from the quick-serve restaurant.

5. The apparatus of claim 1 in which the function provided by the processor comprises responding to control signals from a participant selector to govern the parties to a conversation related to the order.

6. The apparatus of claim 1 in which the function provided by the processor comprises enabling a representative of the quick serve restaurant to listen in on a conversation associated with the order.

7. The apparatus of claim 6 in which the representative may listen in but not participate in the conversation.

8. The apparatus of claim 6 in which the representative comprises a person who is preparing food for the order.

9. The apparatus of claim 6 in which the representative comprises a person who is managing the restaurant.

10. The apparatus of claim 1 in which the function provided by the processor can be controlled by a representative of the restaurant.

11. The apparatus of claim 1 in which the function provided by the processor comprises enabling a representative of the quick serve restaurant to take over a conversation between the customer and an order taker.

12. The apparatus of claim 11 in which the order taker is excluded from the conversation.

13. The apparatus of claim 11 in which the order taker is permitted to listen to but not participate in the conversation.

14. A method comprising
enabling a conversation to occur between a customer of a quick serve restaurant and an order taker located at a remote call center about an order being placed, and
enabling a representative at the quick serve restaurant to listen in to the conversation.

15. The method of claim 14 in which the conversation is enabled by converting between analog speech signals at the quick serve restaurant and Internet protocol packets carried on a network to the remote call center.

16. The method of claim 14 in which the representative is enabled to listen in to the conversation based on a selection made by the representative on a participant selector.

17. The method of claim 14 in which the representative is a person preparing food for the order.

18. The method of claim 14 in which the representative is a person managing the restaurant.

19. The method of claim 14 also comprising enabling the representative who is listening in to the conversation to take over the conversation.

20. A method comprising
enabling a conversation to occur between a customer of a quick serve restaurant and an order taker located at a remote call center about an order being placed, and
enabling a representative at the quick serve restaurant to take over the conversation.

21. The method of claim 20 in which the conversation is enabled by converting between analog speech signals at the quick serve restaurant and Internet protocol packets carried on a network to the remote call center.

22. The method of claim 20 in which the representative is enabled to take over the conversation based on a selection made by the representative on a participant selector.

23. The method of claim 14 in which the representative is a person managing the restaurant.
